(19) United States
(12) Patent Application Publication
(10) Pub. No.: US 2025/0374166 A1
(43) Pub. Date: Dec. 4, 2025

(54) SENSING REQUEST NODE, RESPONSE NODE, AND DATA RELAY TRANSMISSION METHOD

(71) Applicant: Lenovo (Beijing) Limited, Beijing (CN)

(72) Inventors: Jianfeng WANG, Beijing (CN); Haiming WANG, Beijing (CN)

(21) Appl. No.: 19/301,615

(22) Filed: Aug. 15, 2025

Related U.S. Application Data
(63) Continuation of application No. PCT/CN2023/134626, filed on Nov. 28, 2023.

(30) Foreign Application Priority Data
Feb. 17, 2023 (CN) 202310143816.9

(51) Int. Cl. H04W 40/22; H04W 40/12

(52) U.S. Cl. CPC H04W 40/22; H04W 40/12

(57) ABSTRACT

A sensing request node includes a transceiver and a processor configured to, in response to determining that a first response node in a sensing area has not returned first sensing data and receiving the first sensing data from at least one second response node in the sensing area, select a third response node from the at least one second response node, transmit relay configuration information to the first response node and the third response node, and receive second sensing data from the third response node. The second sensing data is the first sensing data retransmitted by the first response node to the third response node according to the relay configuration information.

### CROSS-REFERENCE TO RELATED APPLICATIONS

This application is a continuation of International Patent Application No. PCT/CN2023/134626 filed on Nov. 28, 2023, which claims priority to Chinese Patent Application No. 202310143816.9 filed on Feb. 17, 2023, the entire contents of both of which are incorporated herein by reference.

### FIELD OF THE TECHNOLOGY

The present disclosure relates to, but is not limited to, the field of wireless sensing technology, and in particular to a sensing request node, a response node, and a data relay transmission method.

### BACKGROUND

In recent years, wireless sensing technology has garnered increasing research attention. This technology detects changes in certain characteristics of received wireless signals (such as phase, power, and eigenvalues), and extracts information therefrom or characterizes the occurrence of certain behaviors, thereby fulfilling desired services or facilitating more efficient communication transmission.

However, in multi-node collaborative sensing scenarios, some response nodes within the sensing area may be unable to successfully feedback channel measurement results to the sensing request node due to factors such as long distance or poor channel quality. Even when the response node retransmits this sensing data, the transmission may still fail.

### SUMMARY

In accordance with the disclosure, there is provided a sensing request node including a transceiver and a processor configured to, in response to determining that a first response node in a sensing area has not returned first sensing data and receiving the first sensing data from at least one second response node in the sensing area, select a third response node from the at least one second response node, transmit relay configuration information to the first response node and the third response node, and receive second sensing data from the third response node. The second sensing data is the first sensing data retransmitted by the first response node to the third response node according to the relay configuration information.

Also in accordance with the disclosure, there is provided a first response node including a transceiver and a processor configured to receive relay configuration information transmitted by a sensing request node, and retransmit sensing data generated by channel estimation to a third response node according to the relay configuration information. The third response node is selected from at least one response node in a sensing area by the sensing request node in response to receiving the sensing data from the at least one response node and determining that the first response node has not returned the sensing data.

Also in accordance with the disclosure, there is provided a third response node including a transceiver and a processor configured to receive relay configuration information transmitted by a sensing request node, receive first sensing data retransmitted by a first response node to obtain second sensing data, and transmit the second sensing data to the sensing request node according to the relay configuration information.

### BRIEF DESCRIPTION OF THE DRAWINGS

The accompanying drawings herein are incorporated into and constitute a part of the present disclosure. These drawings illustrate embodiments consistent with the present disclosure and, together with the description, serve to illustrate the technical solutions of the present disclosure.

FIG. 1 is a schematic diagram showing a dual-node collaborative sensing scenario.

FIG. 2 is a schematic diagram showing transmission failure of some nodes in a multi-node collaborative sensing scenario in the related art.

FIG. 3 is a structural diagram of a sensing request node provided in certain embodiments of the present disclosure.

FIG. 4 is a structural diagram of a first response node provided in certain embodiments of the present disclosure.

FIG. 5 is a structural diagram of a third response node provided in certain embodiments of the present disclosure.

FIG. 6 is an architectural diagram of a data relay transmission system provided in certain embodiments of the present disclosure.

FIG. 7 is a flowchart of a data relay transmission method provided in certain embodiments of the present disclosure.

FIG. 8 is an interactive flowchart of a data relay transmission method provided in certain embodiments of the present disclosure.

FIG. 9 is a flowchart of a data relay transmission process provided in certain embodiments of the present disclosure.

FIG. 10 is a schematic diagram showing dynamically negotiating and determining a third response node provided in certain embodiments of the present disclosure.

### DETAILED DESCRIPTION

To help clarify the objectives, technical solutions, and advantages of the present disclosure, description is provided below with reference to the accompanying drawings. The description does not limit the scope of the present disclosure. Other embodiments devised by persons of ordinary skill in the technical field without inventive effort are within the scope of the present disclosure.

References to “certain embodiments” describe a subset of all possible embodiments. However, “certain embodiments” may be the same subset or different subsets of all possible embodiments, and may be combined with each other where no conflict exists.

The terms “first/second/third” are used to distinguish similar objects and do not represent a particular ordering of the objects. The terms “first/second/third” may be interchanged in any suitable order, where permitted, so that the embodiments described herein may be implemented in an order other than that illustrated or described herein.

Unless otherwise defined, all technical and scientific terms used herein have the same meaning as commonly understood by persons skilled in the technical field to. The terminology used herein is for descriptive purposes and is not intended to limit the scope of the present disclosure.

Wireless sensing technology may be applied in a wide range of scenarios, including touchless control (such as gesture recognition), elderly care (such as fall detection), health monitoring (such as heart rate and breathing detection), weather detection (such as rain and snow detection), UAV detection (such as illegal flying object detection), environmental monitoring (such as dangerous event alarms), and intelligent transportation assistance. Therefore, enhancing support for sensing capabilities in existing wireless communication systems has become a topic for various standards organizations.

SparkLink is a new short-range wireless communication system standard that provides wireless transmission capabilities that meet short-range business needs. The established SparkLink 1.0 air interface standard includes a basic version (SparkLink Basic, SLB) that supports ultra-low latency and a low-power version (SparkLink Low-Energy, SLE) that supports low-power transmission.

A typical two-node collaborative sensing scenario is shown in FIG. 1. Node A within the sensing area transmits a sensing signal 11 to node B. Node B performs channel estimation based on this sensing signal 11 and feeds the estimated channel state information (CSI) back to node A as sensing data 12. Node A analyzes this sensing data 12 using a sensing algorithm to obtain sensing results, such as the movement speed and posture of sensing target 13, as well as other sensing-related results.

To obtain good channel state information and potential channel variation characteristics, the sensing signal uses a sequence with good autocorrelation and cross-correlation properties, such as the ZC (Zadoff Chu) sequence. This allows the receiving node to achieve good channel estimation even under low signal-to-noise ratio conditions. Sensing data, on the other hand, is generally quantized channel state information. The amount of feedback depends on the required quantization accuracy. Higher quantization accuracy allows for more accurate analysis of channel changes at the receiver, but this requires more uplink resources, including those in the time, frequency, and spatial domains, as well as power. From the perspective of uplink and downlink budgets, downlink (for example, sensing signal transmission and reception) coverage may be much greater than uplink (for example, sensing data transmission and reception).

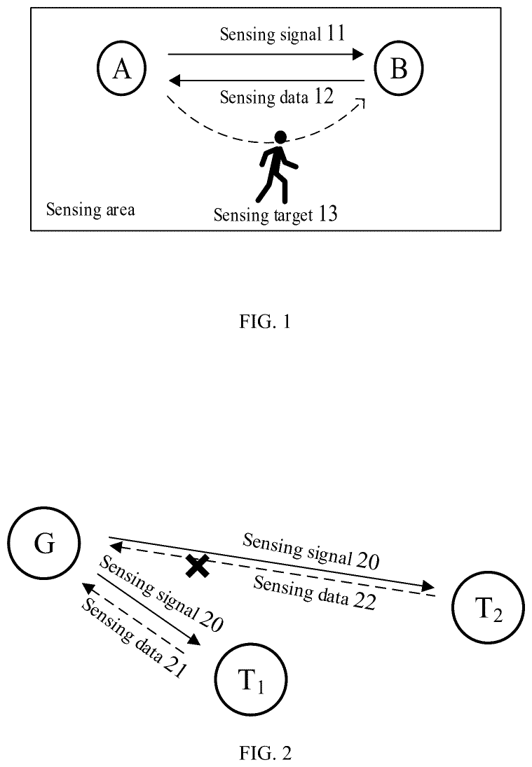

In a multi-node collaborative sensing scenario, as shown in FIG. 2, within the sensing area, node G acts as the sensing request node and performs collaborative sensing with nodes T1 and T2, which act as sensing response nodes. Node G first transmits a sensing signal 20 (indicated by the solid arrows) to nodes T1 and T2 using predefined sensing configuration information. Upon receiving this signal, nodes T1 and T2 perform channel estimation and, based on the sensing configuration information, feedback sensing data to node G (indicated by the dashed arrows). Because node T1 is closer to node G (or has better channel quality), node T1 receives sensing data 21 on the G-T1 channel. However, because node T2 is farther away (or has poor channel quality), node T2 may not receive sensing data 22 on the G-T2 channel. Although node T2 may retransmit the sensing data to node G, due to the long distance (or poor channel quality), node G may still not receive the data.

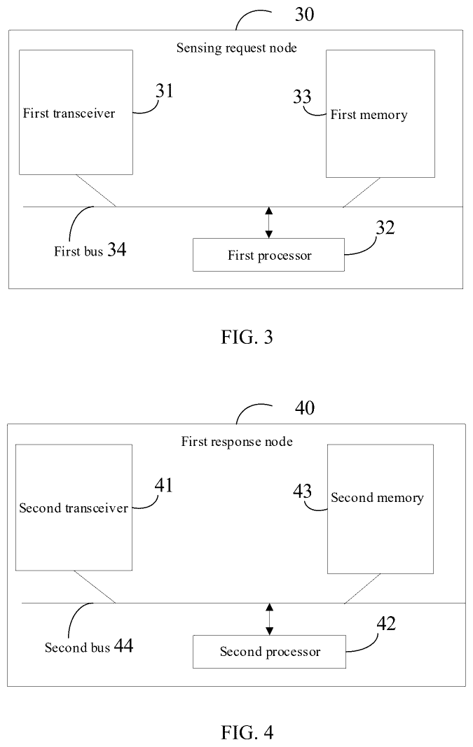

FIG. 3 is a structural diagram of a sensing request node provided in certain embodiments of the present disclosure. As shown in FIG. 3, the sensing request node 30 (equivalent to the aforementioned node G) includes: a first transceiver 31 and a first processor 32, as well as a first memory 33 and a first bus 34. The sensing request node 30 may be a server, a laptop computer, a tablet computer, a desktop computer, a smart TV, a set-top box, a mobile device (such as a mobile phone, a portable video player, a personal digital assistant, a dedicated messaging device, a portable gaming device), or other device with data transmission capabilities. FIG. 3 is an exemplary structural diagram. In addition to the functional units shown in FIG. 3, the sensing request node 30 may also include other functional units, which are not limited in the embodiments of the present disclosure.

The first transceiver 31 may be a communication component, for example, a communication chip, or it may include multiple components including both a receiver and a transmitter.

The first transceiver 31 and the first memory 33 are each connected to the first processor 32 via a first bus 34. The first memory 33 may be used to store computer software programs and various types of data generated during data relay transmission, including configuration parameters, signaling, and sensing data packets.

In addition, the first memory 33 may be implemented by any type of volatile or non-volatile storage device, or a combination thereof. Volatile or non-volatile storage devices include, but are not limited to, magnetic or optical disks, EEPROM (Electrically Erasable Programmable Read-Only Memory), EPROM (Erasable Programmable Read-Only Memory), SRAM (Static Random Access Memory), ROM (Read-Only Memory), magnetic storage, flash memory, and PROM (Programmable Read-Only Memory).

The first processor 32 includes one or more processing cores. The first processor 32 executes various functional applications and information processing by running computer software programs and various functional modules. To implement the data relay transmission method on the sensing request node side, in certain embodiments of the present disclosure, the first processor 32 performs the following operations:

At S310, upon receiving first sensing data from at least one second response node within the sensing area, and when there is a first response node within the sensing area that has not returned the first sensing data, the sensing request node selects a third response node from the at least one second response node.

In certain embodiments, the first sensing data is generated by channel estimation, and is typically quantized channel state information (CSI), such as spatial angle information. Both the first and second response nodes are response nodes within the sensing area and may perform channel estimation based on the sensing signal transmitted by the sensing request node. The first response node is a response node that failed to transmit the first sensing data, equivalent to the aforementioned node T2. The second response node is a response node that successfully transmitted the first sensing data, equivalent to the aforementioned node T1.

In implementation, the sensing request node, based on the sensing configuration, first transmits a sensing signal to all response nodes within the sensing area, triggering each response node to perform channel estimation. It then receives the first sensing data returned by each response node at the configured response reception time and frequency domain. In the event that the first sensing data fed back by the first response node is not received by the configured response reception time, certain embodiments of the present disclosure select a qualified third response node from other second response nodes that have successfully performed transmission for relay transmission via the third response node.

At S320, the sensing request node transmits relay configuration information to the first and third response nodes.

In certain embodiments, the relay configuration information is used to configure the signaling and data transmission format between the first and third response nodes. In implementation, the sensing request node may configure the same or different information for the first and third response nodes via the relay configuration information.

At S330, the sensing request node receives the second sensing data forwarded by the third response node according to the relay configuration information; the second sensing data is the first sensing data retransmitted by the first response node to the third response node according to the relay configuration information.

In certain embodiments of the present disclosure, in the event that the transmission of the first sensing data by some first response nodes fails in a multi-node collaborative sensing scenario, the sensing request node selects a third response node from the second response nodes that successfully transmitted the data, configures relay configuration information, and receives the second sensing data transmitted by the third response node via relay transmission, thereby achieving timely and effective data feedback and improving sensing performance.

In certain embodiments, the first processor is further configured to perform the following operations: transmitting a sensing signal to all response nodes within the sensing area; where the sensing signal is used for channel estimation; and receiving the first sensing data fed back by all response nodes.

The sensing signal is a sequence with good autocorrelation and cross-correlation characteristics, such as a ZC sequence. The sensing signal may be transmitted to all response nodes via broadcast, multicast, or unicast. In this way, the sensing request node triggers all response nodes to perform channel estimation and receives the first sensing data via the sensing signal, which completes a sensing process.

In certain embodiments, the first processor selecting a third response node from the at least one second response node includes: obtaining data transmission capabilities of each of the at least one second response node; where the data transmission capabilities include at least one of the following: signal transmission quality, spatial angle-of-arrival capability, and location distribution; and determining the third response node from the at least one second response node based on the data transmission capabilities.

In certain embodiments, the sensing request node selects the second response node with the highest signal-to-noise ratio as the third response node based on the signal transmission quality; or, based on the location distribution, selects the second response node closest to the first response node as the third response node; or, based on the spatial angle-of-arrival capability, selects the second response node with the same or similar arrival angle as the first response node as the third response node. This helps ensure efficiency of subsequent transmission of second sensing data by the third response node to the sensing request node.

In certain embodiments, the first processor selecting a third response node from the at least one second response node includes: receiving a channel measurement result transmitted by each second response node; where the channel measurement result represents the channel quality between the corresponding second response node and the first response node; and determining the third response node from the at least one second response node based on the channel measurement result.

In this way, the sensing request node can select the best one from all second response nodes that have fed back channel measurement results as the third response node, thereby improving the relay transmission quality of the second sensing data.

In certain embodiments, the first processor transmitting relay configuration information to the first response node and the third response node includes: transmitting first configuration information to the first response node; where the first configuration information includes at least the following information: a frame number of a radio frame for transmitting the first sensing data to the third response node and a physical layer identifier of the third response node; and transmitting second configuration information to the third response node; where the second configuration information includes at least the following information: a frame number of a radio frame for receiving the first sensing data from the first response node, a frame number of a radio frame for reporting the second sensing data to the sensing request node and a transmission format, and a physical layer identifier of the first response node.

In this way, the sensing request node configures the first and third response nodes using the first and second configuration information, respectively, thereby configuring the first and third response nodes to use direct communication transmission characteristics. This enables relay transmission, saves signaling space, and improves transmission efficiency.

FIG. 4 is an exemplary structural diagram of a first response node provided in certain embodiments of the present disclosure. As shown in FIG. 4, the first response node 40 (equivalent to the aforementioned node T2, for example, the transmission failure node) includes a second transceiver 41 and a second processor 42, as well as a second memory 43 and a second bus 44. FIG. 4 is an exemplary structural diagram. In addition to the functional units shown in FIG. 4, the first response node 40 may also include other functional units, which are not limited in embodiments of the present disclosure.

The second transceiver 41 may be a communication component, for example, a communication chip, or it may include multiple components including both a receiver and a transmitter.

The second transceiver 41 and the second memory 43 are connected to the second processor 42 via a second bus 44. The second memory 43 may be used to store computer software programs and various data generated during data relay transmission, including configuration parameters, signaling, and sensing data packets. Furthermore, the second memory 43 may be implemented by any type of volatile or non-volatile storage device, or a combination thereof.

The second processor 42 includes one or more processing cores. The second processor 42 executes computer software programs and various functional modules to perform various functional applications and information processing. To implement the data relay transmission method on the first response node side, the second processor 42 in certain embodiments of the present disclosure performs the following operations:

S410, the first response node receives relay configuration information transmitted by the sensing request node.

S420, the first response node retransmits first sensing data to a third response node based on the relay configuration information. The first sensing data is generated by channel estimation. The third response node is selected by the sensing request node from among the at least one second response node within the sensing area after receiving first sensing data fed back by the at least one second response node within the sensing area and there exists a first response node within the sensing area that has not returned the first sensing data.

In certain embodiments of the present disclosure, after failing to feedback first sensing data to a sensing request node, a first response node receives relay configuration information transmitted by the sensing request node. The node then retransmits the first sensing data to a third response node according to the transmission format configured in the relay configuration information, thereby enabling timely and efficient transmission of the first sensing data via relay forwarding by the third response node.

In certain embodiments, the relay configuration information is first configuration information, which includes at least the following information: the frame number of the radio frame for receiving the first sensing data from the first response node, the frame number of the radio frame for reporting the second sensing data to the sensing request node and the transmission format, and the physical layer identifier of the first response node. In certain embodiments, the first configuration information includes the transmission format of the second sensing data transmitted to the third response node. Thus, by transmitting the first configuration information to the first response node, the transmission format of the first sensing data retransmitted by the first response node to the third response node may be configured to meet the requirements of direct communication between the two nodes.

In certain embodiments, the second processor is further configured to perform the following operations: the first response node transmits a predefined multicast channel detection signal to the at least one second response node; the multicast channel detection signal is used to trigger each second response node to measure the channel quality between itself and the first response node, so that the sensing request node may determine the third response node. In this way, the multicast channel detection signal triggers each second response node to measure the channel quality and provide feedback to the sensing request node, thereby dynamically selecting the third response node as the suitable relay auxiliary node for the first response node.

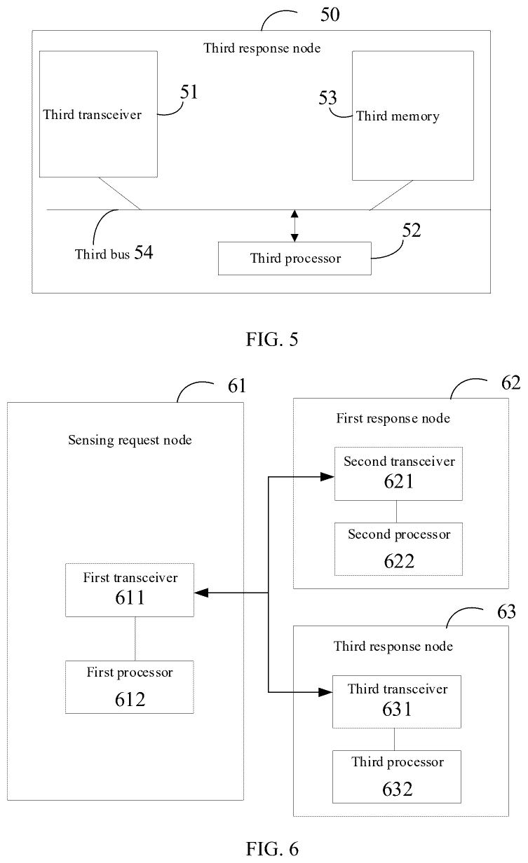

FIG. 5 is an exemplary structural diagram of a third response node provided in certain embodiments of the present disclosure. As shown in FIG. 5, the third response node 50 (equivalent to the aforementioned node T, for example, a relay auxiliary node) includes: a third transceiver 51 and a third processor 52, as well as a third memory 53 and a third bus 54. FIG. 5 is an exemplary structural diagram. In addition to the functional units shown in FIG. 5, the third response node 50 may also include other functional units, which are not limited in embodiments of the present disclosure.

The third transceiver 51 may be a communication component, for example, a communication chip, or it may include multiple components including both a receiver and a transmitter.

The third transceiver 51 and the third memory 53 are each connected to the third processor 52 via a third bus 54. The third memory 53 may be used to store computer software programs and various data generated during data relay transmission, including configuration parameters, signaling, and sensing data packets. Furthermore, the third memory 53 may be implemented by any type of volatile or non-volatile storage device, or a combination thereof.

The third processor 52 includes one or more processing cores. The third processor 52 executes computer software programs and various functional modules to perform various functional applications and information processing. To implement the data relay transmission method on the third response node side, the third processor 52 in certain embodiments of the present disclosure performs the following operations:
S510: the third response node receives relay configuration information transmitted by the sensing request node;
S520: the third response node receives first sensing data retransmitted by the first response node to obtain second sensing data; where the first sensing data is generated by channel estimation;
S530: the third response node transmits the second sensing data to the sensing request node based on the relay configuration information.

In certain embodiments, the relay configuration information is second configuration information, including at least the following information: the frame number of the radio frame for receiving the first sensing data from the first response node, the frame number of the radio frame for reporting the second sensing data to the sensing request node and the transmission foramt, and the physical layer identifier of the first response node. In certain embodiments, the second configuration information also includes the transmission format of the retransmitted sensing data received by the third response node from the first response node.

Certain embodiments of the present disclosure provide a data relay transmission system, as shown in FIG. 6. The system includes a sensing request node 61, a first response node 62, and a third response node 63. The sensing request node 61 includes at least a first transceiver 611 and a first processor 612; the first response node 62 includes at least a second transceiver 621 and a second processor 622; and the third response node 63 includes at least a third transceiver 631 and a third processor 632. The first transceiver 611, the second transceiver 621, and the third transceiver 631 are communicatively connected to each other.

In certain embodiments, the first processor 612 performs the following operations: upon receiving first sensing data fed back by at least one second response node within a sensing area and existence of a first response node within the sensing area that has not returned the first sensing data, selects a third response node from the at least one second response node; where the first sensing data is generated by channel estimation; transmits relay configuration information to the first response node and the third response node; and receives second sensing data forwarded by the third response node based on the relay configuration information; where the second sensing data is the first sensing data retransmitted by the first response node to the third response node based on the relay configuration information.

In certain embodiments, the second processor 622 performs the following operations: receives relay configuration information transmitted by a sensing request node; and retransmits the first sensing data to the third response node based on the relay configuration information.

In certain embodiments, the third processor 632 performs the following operations: receives relay configuration information transmitted by the sensing request node; receives the first sensing data retransmitted by the first response node to obtain second sensing data; and transmits the second sensing data to the sensing request node based on the relay configuration information.

The data relay transmission system provided in certain embodiments addresses the situation where the transmission of first sensing data from some first response nodes fails in a multi-node collaborative sensing scenario. This system retransmits the first sensing data by configuring a third response node as a relay auxiliary node. The sensing request node aggregates the first sensing data from all sensing response nodes and calculates the sensing result. This enables timely and effective feedback and aggregation of the first sensing data from all response nodes, improving sensing performance.

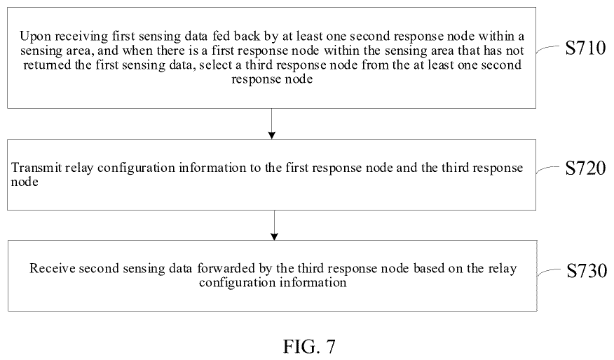

Certain embodiments provide a data relay transmission method that may be executed by a first processor of a sensing request node. FIG. 7 is a schematic diagram of a flow chart of the data relay transmission method provided in certain embodiments. As shown in FIG. 7, the method includes the following operations:
S710: Upon receiving first sensing data fed back by at least one second response node within a sensing area, and when there is a first response node within the sensing area that has not returned the first sensing data, select a third response node from the at least one second response node.

In certain embodiments, the first sensing data is generated by channel estimation.
S720: Transmit relay configuration information to the first response node and the third response node.
S730: Receive second sensing data forwarded by the third response node based on the relay configuration information.

In certain embodiments, the second sensing data is the first sensing data retransmitted by the first response node to the third response node based on the relay configuration information.

In certain embodiments of the present disclosure, in the event that the first sensing data transmission of some first response nodes fails in a multi-node collaborative sensing scenario, the sensing request node selects a third response node from the second response nodes that successfully transmitted the data, configures relay configuration information, and receives the second sensing data transmitted by the third response node via relay transmission, thereby achieving timely and effective data feedback and improving sensing performance.

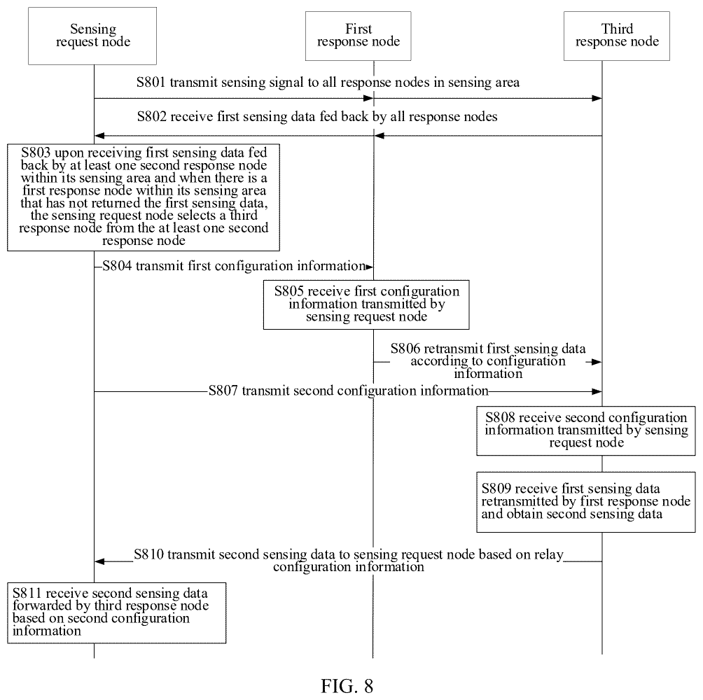

FIG. 8 is an interactive flow chart of the data relay transmission method provided in certain embodiments of the present disclosure. As shown in FIG. 8, the method includes the following operations:

At S801, a sensing request node transmits a sensing signal to all response nodes within its sensing area.

In certain embodiments, the sensing signal is used for channel estimation. In implementation, the sensing signal may be a sequence with good autocorrelation and cross-correlation characteristics, such as a ZC sequence.

S802, the sensing request node receives the first sensing data fed back by all response nodes.

In certain embodiments, the first sensing data is generated by channel estimation and is typically quantized channel state information (CSI), such as spatial angle information.

S803, upon receiving first sensing data fed back by at least one second response node within its sensing area and when there is a first response node within its sensing area that has not returned the first sensing data, the sensing request node selects a third response node from the at least one second response node.

S804, the sensing request node transmits first configuration information to the first response node.

In certain embodiments, the first configuration information includes at least the following information: the frame number of the radio frame for transmitting the first sensing data to the third response node and the physical layer identifier of the third response node.

S805, the first response node receives the first configuration information transmitted by the sensing request node.

S806, the first response node retransmits the first sensing data to the third response node based on the first configuration information.

In certain embodiments, the first sensing data is generated by channel estimation. The third response node is selected by the sensing request node from at least one second response node within the sensing area after receiving first sensing data fed back by the sensing request node and when there is a first response node within the sensing area that has not returned the first sensing data.

S807, the first response node transmits second configuration information to the third response node.

In certain embodiments, the second configuration information includes at least the following information: the frame number of the radio frame for receiving the first sensing data from the first response node, the frame number of the radio frame for reporting the second sensing data to the sensing request node and the transmission format, and the physical layer identifier of the first response node.

In S804 and S807, the first configuration information and the second configuration information may be transmitted simultaneously or sequentially, but both are transmitted after the sensing request node determines the third response node. In certain embodiments, the contents of the first configuration information and the second configuration information may be combined into relay configuration information and transmitted to the first and third response nodes.

S808: The third response node receives the second configuration information transmitted by the sensing request node.

S809: The third response node receives the first sensing data retransmitted by the first response node to obtain second sensing data.

In certain embodiments, the first sensing data is generated by channel estimation.

The order of executing S808 and S809 is not limited and they may be executed simultaneously, for example, receiving data in different frequency domains, or S809 may be executed before S808.

S810, the third response node transmits the second sensing data to the sensing request node based on the relay configuration information.

S811, the sensing request node receives the second sensing data forwarded by the third response node based on the second configuration information.

In certain embodiments, the second sensing data is the first sensing data retransmitted by the first response node to the third response node based on the first configuration information.

In certain embodiments of the present disclosure, in the event that some first response nodes fail to transmit their first sensing data in a multi-node collaborative sensing scenario, the sensing request node selects a third response node from among the second response nodes that successfully transmitted the data, configures relay configuration information, and receives the second sensing data transmitted by the third response node via relay transmission, thereby achieving timely and effective data feedback and improving sensing performance.

The data relay transmission method described above is described below with reference to certain embodiments. Certain embodiments are provided to better illustrate the present disclosure and do not constitute an undue limitation of the present disclosure.

Due to certain enhancements to the SparkLink air interface in the SparkLink positioning project, flexible configuration of the frame structure and control channel content enables Nodes T to communicate directly with nodes G. Therefore, certain embodiments of the present disclosure utilize this feature of SparkLink to relay failed first sensing data through other second response nodes that previously successfully transmitted data, enabling timely and effective data feedback and improving sensing performance.

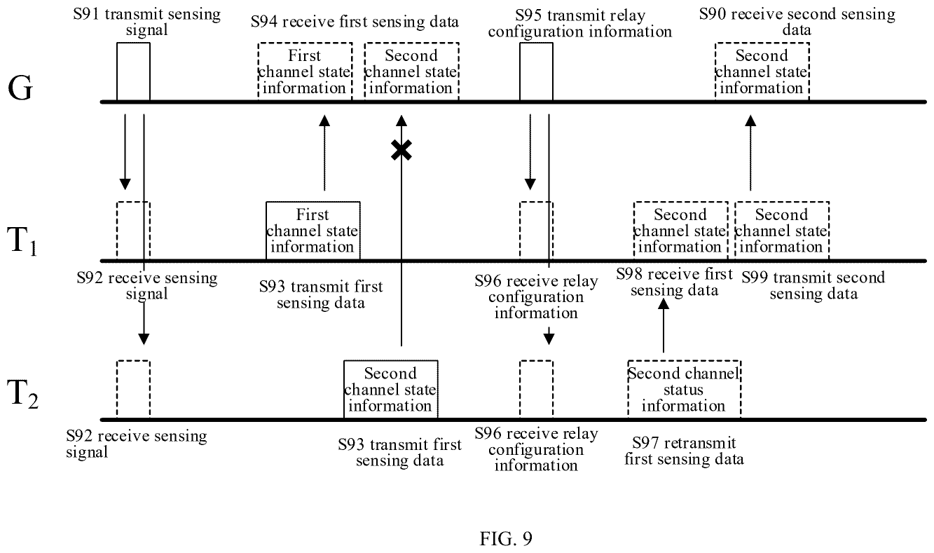

The basic data relay transmission process provided in certain embodiments of the present disclosure is shown in FIG. 9, assuming that node G is the sensing requesting and sensing signal transmission node, for example, the sensing request node. The sensing data from sensing response nodes T1 and T2 are aggregated and resolved to obtain the sensing result.

Based on the sensing service request, the sensing service module determines the sensing area and, through the node G, queries the sensing capabilities of the Nodes T within its coverage area. It then acts as the sensing request node and selects sensing response nodes, such as T1 and T2. After determining all participating sensing nodes, the node G configures sensing-related transmission configurations for all response nodes, including the sensing signal transmission and reception formats and the first sensing data feedback configuration. At the configured signal transmission time and frequency, the node G executes S91 to transmit the sensing signal to all response nodes (Nodes T, such as T1 and T2 shown in FIG. 9). This sensing signal may be transmitted via broadcast, multicast, or unicast.

After receiving the sensing signal, all response nodes (Nodes T) execute S92 and process it according to the configuration information, such as obtaining channel state information. They then quantize or further process the channel state information according to the predefined sensing configuration information, such as obtaining spatial angle information. Based on the data feedback configuration information in the sensing configuration information, all response nodes (Nodes T) execute S93 to transmit the first sensing data to the node G at the specified time and frequency. As shown in FIG. 9, the node T1 feeds back the first channel state information (CSI information of the channel between G and T1), and the node T2 feeds back the second channel state information (CSI information of the channel between G and T2).

At the response configuration moment, node G executes S94 to receive the first sensing data. As shown in FIG. 9, node G receives the first sensing data representing first state information from node T1. However, due to the distance between node T2 and node G or poor channel quality, node G does not correctly receive the first sensing data representing second state information from node T2. In certain embodiments of the present disclosure, node T2 acts as the first response node, and node T1 acts as the second response node. Node G selects a suitable node T2 from among all response nodes (Nodes T) as the third response node, or relay auxiliary node, to relay its first sensing data, assisting the failed T1 node.

After determining the third response node, node G is to configure the transmission format for the third response node (for example, node T1 in FIG. 9) and the first response node (for example, node T2 in FIG. 3). Therefore, node G executes S95 to transmit relay configuration information, setting different configuration information for different response nodes.

The relay configuration information configured for the third response node may include: the frame number of the radio frame for retransmitting the first sensing data from the first response node, the frame number of the radio frame for relaying the second sensing data to the node G, the transmission format of the sensing data packet relayed to the node G, the physical layer identification ID number of the first response node, and/or the transmission format of the first sensing data retransmitted from the first response node.

In certain embodiments, the relay configuration information configured for the first response node may include: the frame number of the radio frame for retransmitting the first sensing data to the third response node, the physical layer identification ID number of the third response node, and/or the transmission format of the first sensing data retransmitted to the third response node.

In certain embodiments, the first response node (such as node T2 in FIG. 9) executes S97 to retransmit the first sensing data to the third response node (node T1 in FIG. 9) based on the relay configuration information. After receiving the first sensing data at S98, the third response node (node T1 in FIG. 9) executes S99 to transmit the second sensing data (for example, the first sensing data retransmitted by T2) to the node G based on the relay configuration information. After receiving the second sensing data at S90, the node G fuses it with the first sensing data previously received from other nodes, and calculates and obtains the sensing result, performing a sensing process.

In certain embodiments, the node G may select the third response node in one or both of the following two manners:

First, direct selection by the node G:

In certain embodiments, the node G selects the node T with the best received signal (for example, the highest signal-to-noise ratio) as the third response node based on the received signal quality at the previous moment. This ensures the reception quality of the second sensed data that is subsequently relayed and retransmitted.

In certain embodiments, when the node G knows the location distribution of all response nodes (Nodes T), it may select a node T (for example, the second response node) that is near the first response node where the transmission failed and has successfully transmitted the first sensed data as the third response node for relaying.

In certain embodiments, when the node G has the ability to estimate the spatial signal arrival angle, it may select a node T (for example, the second response node) that has successfully transmitted the first sensed data at the same or similar arrival angle as the node where the transmission failed as the third response node for relaying.

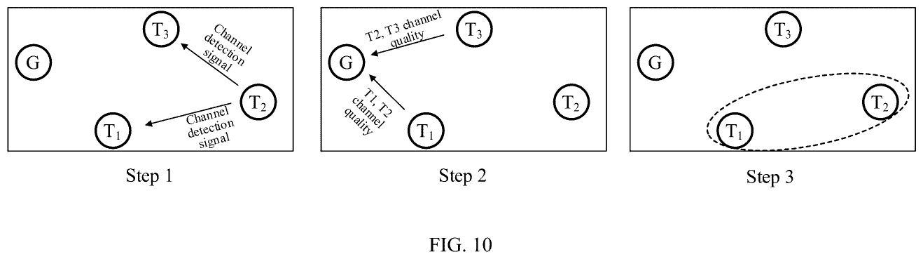

Second, dynamic negotiation assisted by the node G, as shown in FIG. 10, includes the following:

The first response node (such as node T2 in FIG. 10) that failed to transmit transmits a predefined multicast channel detection signal within its sensing area. All second response nodes (such as nodes T1 and T3 in FIG. 10) that successfully transmitted the first sensing data receive the signal and measure the channel quality between them and the first response node.

All Nodes T (such as nodes T1 and T3 in FIG. 10) that received the channel probing signal feedback their measurement results to the node G. As shown in FIG. 10, node T1 feeds back the channel quality from T1 to T2, and node T3 feeds back the channel quality from T2 to T3.

Based on the measurement results, node G selects a third response node (such as node T1 in FIG. 10) as the suitable relay node for the first response node. The first and third response nodes are configured to relay the first sensing data.

Certain embodiments of the present disclosure utilize the ability to configure direct communication between nodes in the SparkLink air interface. In multi-node collaborative sensing scenarios, when some nodes experience data transmission failure, the failed sensing data is retransmitted by configuring relay nodes. This solution involves signaling related to relay configuration. This solution enables timely and effective aggregation of sensing data, improving sensing performance.

In certain embodiments, the functions or modules included in the devices provided by certain embodiments of this disclosure may be used to perform the methods described in the aforementioned method embodiments. For technical details not disclosed in the device embodiments, further understanding may be had by referring to the description of the method embodiments.

When the aforementioned data relay transmission method is implemented as a software functional module and sold or used as a standalone product, it may also be stored in a computer-readable storage medium. The technical solution of the embodiments of the present disclosure may be embodied in the form of a software product stored in a storage medium and containing instructions for enabling a computer device (such as a personal computer, server, or network device) to perform all or some of the methods described in the various embodiments of the present disclosure. The aforementioned storage media include various media capable of storing program code, such as a USB flash drive, a mobile hard drive, a read-only memory (ROM), a magnetic disk, or an optical disk. Thus, the embodiments of the present disclosure are not limited to any specific hardware, software, or firmware, or any combination of hardware, software, or firmware.

Certain embodiments of the present disclosure provide a computer device including a memory and a processor. The memory stores a computer program executable on the processor. When the processor executes the program, it implements some or all of the operations in the aforementioned method for relaying data on a requesting node; or some or all of the operations in the aforementioned method for relaying data on a first response node; or some or all of the operations in the aforementioned method for relaying data on a third response node.

Certain embodiments of the present disclosure provide a computer-readable storage medium storing a computer program. When executed by the processor, the computer program implements some or all of the operations in the aforementioned method for relaying data on any of the requesting node, first response node, or third response node. The computer-readable storage medium may be volatile or non-volatile.

Certain embodiments of the present disclosure provide a computer program including computer-readable code. When the computer-readable code is executed in the computer device, the processor in the computer device executes the operations for implementing some or all of the aforementioned methods for relaying data on any of the requesting node, first response node, or third response node.

Embodiments of the present disclosure provide a computer program product including a non-transitory computer-readable storage medium storing a computer program. When the computer program is read and executed by a computer, it implements some or all of the operations of the above-described method. The computer program product may be implemented in hardware, software, or a combination thereof. In certain embodiments, the computer program product is embodied as a computer storage medium. In other embodiments, the computer program product is embodied as a software product, such as a software development kit (SDK).

The description of the various embodiments tends to emphasize the differences between the embodiments, and reference may be made to the similarities or similarities between them. The descriptions of the above embodiments of the device, storage medium, computer program, and computer program product are similar to the description of the above-described method embodiments and have similar beneficial effects as the method embodiments. For technical details not disclosed in the embodiments of the device, storage medium, computer program, and computer program product, understanding may be had by referring to the description of the method embodiments.

References to “one embodiment” or “certain embodiments” throughout the present disclosure refer to a particular feature, structure, or characteristic. Therefore, “in one embodiment” or “in certain embodiments” throughout the present disclosure do not refer to the same embodiment. Furthermore, these particular features, structures, or characteristics may be combined in any suitable manner in one or more embodiments. In the various embodiments of the present disclosure, the order of the operations/processes described above does not imply a sequential order of execution. The order of execution of the operations/processes may be determined by their functionality and inherent logic and does not constitute any limitation on the implementation of the embodiments of the present disclosure. The numbering of the embodiments of the present disclosure is for descriptive purposes only and does not represent the superiority or inferiority of the embodiments.

The terms “include” and “comprise” or any other variations thereof are intended to encompass non-exclusive inclusion, such that a process, method, article, device, or apparatus including a list of elements includes not only those elements but also other elements not expressly listed, or elements inherent to such process, method, article, device, or apparatus. Without further constraints, an element defined by the phrase “comprises a . . . ” does not exclude the existence of other identical elements in the process, method, article, device, or apparatus that includes the element.

The disclosed devices and methods may be implemented in other ways. The device embodiments described above are merely illustrative. For example, the division of units is merely a logical functional division. Implementations may employ alternative divisions, such as combining multiple units or components, integrating them into another system, or omitting or disabling certain features. Furthermore, the coupling, direct coupling, or communication connection between the components shown or discussed may be through interfaces. Indirect coupling or communication connections between devices or units may be electrical, mechanical, or other forms.

The units described above as separate components may or may not be physically separate, and the components shown as units may or may not be physical units. They may be located in one location or distributed across multiple network units. Some or all of these units may be selected to achieve the objectives of certain embodiments as needed.

Furthermore, the functional units in the various embodiments of the present disclosure may be integrated into a single processing unit, each unit may be independently configured as a separate unit, or two or more units may be integrated into a single unit. These integrated units may be implemented in hardware or as a combination of hardware and software functional units.

All or some of the operations in the aforementioned method embodiments may be performed by hardware associated with program instructions. The aforementioned program may be stored in a computer-readable storage medium, which, when executed, performs the operations of the aforementioned method embodiments. The aforementioned storage medium includes various media capable of storing program code, such as mobile storage devices, read-only memories (ROM), magnetic disks, or optical disks.

When the integrated units described above are implemented as software modules and sold or used as standalone products, they may also be stored on a computer-readable storage medium. The technical solution may be embodied in the form of a software product. This computer software product, stored on a storage medium, includes instructions for enabling a computer device (such as a personal computer, server, or network device) to perform all or some of the methods described in the various embodiments. The aforementioned storage media include various media capable of storing program code, such as removable storage devices, ROM, magnetic disks, or optical disks.

The scope of the present disclosure is not limited to what is described herein. Any modifications or substitutions that may be readily conceived by a person skilled in the technical field are covered by the scope of the present disclosure.

What is claimed is:

1. A sensing request node comprising:
a transceiver; and
a processor configured to:
in response to determining that a first response node in a sensing area has not returned first sensing data and receiving the first sensing data from at least one second response node in the sensing area, select a third response node from the at least one second response node;
transmit relay configuration information to the first response node and the third response node; and
receive second sensing data forwarded by the third response node based on the configuration information, the second sensing data being the first sensing data retransmitted by the first response node to the third response node according to the relay configuration information.

2. The sensing request node of claim 1, wherein the processor is further configured to:
transmit a sensing signal to all response nodes in the sensing area, the sensing signal being configured for channel estimation.

3. The sensing request node of claim 1, wherein the processor is further configured to, when selecting the third response node:
obtain data transmission capability of the at least one second response node, the data transmission capability including one or more of signal transmission quality, spatial angle-of-arrival capability, and location distribution; and
select the third response node from the at least one second response node according to the data transmission capability.

4. The sensing request node of claim 1, wherein the processor is further configured to, when selecting the third response node:
receive one or more channel measurement results each from one of the at least one second response node, each of the one or more channel measurement results representing a channel quality between a corresponding one of the at least one second response node and the first response node; and
select the third response node from the at least one second response node according to the one or more channel measurement results.

5. The sensing request node of claim 1, wherein the processor is further configured to, when transmitting the relay configuration information:
transmit first configuration information to the first response node, the first configuration information including one or more of: a frame number of a radio frame for transmitting the first sensing data to the third response node and a physical layer identifier of the third response node; and
transmit second configuration information to the third response node, the second configuration information including one or more of: a frame number of a radio frame for receiving the first sensing data from the first response node, a frame number of a radio frame for reporting the second sensing data to the sensing request node and a transmission format, and a physical layer identifier of the first response node.

6. The sensing request node of claim 1, wherein the first sensing data of one second response node of the at least one second response node includes channel state information of the one second response node.

7. The sensing request node of claim 1, wherein the second sensing data includes channel state information of the first response node.

8. A method performed by the sensing request node of claim 1, comprising:
in response to determining that the first response node in the sensing area has not returned the first sensing data and receiving the first sensing data from the at least one second response node in the sensing area, selecting the third response node from the at least one second response node;
transmitting the relay configuration information to the first response node and the third response node; and
receiving the second sensing data from the third response node, the second sensing data being the first sensing data retransmitted by the first response node to the third response node according to the relay configuration information.

9. The method of claim 8, further comprising:
transmitting a sensing signal to all response nodes in the sensing area, the sensing signal being configured for channel estimation.

10. The method of claim 8, wherein selecting the third response node includes:
obtaining data transmission capability of the at least one second response node, the data transmission capability including one or more of signal transmission quality, spatial angle-of-arrival capability, and location distribution; and
selecting the third response node from the at least one second response node according to the data transmission capability.

11. The method of claim 8, wherein selecting the third response node includes:
receiving one or more channel measurement results each from one of the at least one second response node, each of the one or more channel measurement results representing a channel quality between a corresponding one of the at least one second response node and the first response node; and
selecting the third response node from the at least one second response node according to the one or more channel measurement results.

12. The method of claim 8, wherein transmitting the relay configuration information includes:
transmitting first configuration information to the first response node, the first configuration information including one or more of: a frame number of a radio frame for transmitting the first sensing data to the third response node and a physical layer identifier of the third response node; and
transmitting second configuration information to the third response node, the second configuration information including one or more of: a frame number of a radio frame for receiving the first sensing data from the first response node, a frame number of a radio frame for reporting the second sensing data to the sensing request node and a transmission format, and a physical layer identifier of the first response node.

13. The method of claim 8, wherein the first sensing data of one second response node of the at least one second response node includes channel state information of the one second response node.

14. The method of claim 8, wherein the second sensing data includes channel state information of the first response node.

15. A first response node comprising:
a transceiver; and
a processor configured to:
receive relay configuration information transmitted by a sensing request node; and
retransmit sensing data generated by channel estimation to a third response node according to the relay configuration information, the third response node being selected from at least one response node in a sensing area by the sensing request node in response to receiving the sensing data from the at least one response node and determining that the first response node has not returned the sensing data.

16. A method performed by the first response node of claim 15, comprising:
receiving the relay configuration information transmitted by the sensing request node; and
retransmitting the sensing data generated by channel estimation to the third response node according to the relay configuration information, the third response node being selected from the at least one response node in the sensing area by the sensing request node in response to receiving the sensing data from the at least one response node and determining that the first response node has not returned the sensing data.

17. A third response node comprising:
a transceiver; and
a processor configured to:
receive relay configuration information transmitted by a sensing request node;
receive first sensing data retransmitted by a first response node to obtain second sensing data; and
transmit the second sensing data to the sensing request node according to the relay configuration information.

18. The third response node of claim 17, wherein the processor is further configured to:
receive sensing signal from the sensing request node; and
transmit the first transmitting data to the sensing request node according to the sensing signal.

19. A method performed by the third response node of claim 17, comprising:
receiving relay configuration information transmitted by the sensing request node;
receiving the first sensing data retransmitted by the first response node to obtain the second sensing data; and
transmitting the second sensing data to the sensing request node according to the relay configuration information.

20. The method of claim 19, further comprising:
receiving sensing signal from the sensing request node; and
transmitting the first transmitting data to the sensing request node according to the sensing signal.
